(19) United States
(12) Patent Application Publication
(10) Pub. No.: US 2012/0161456 A1
(43) Pub. Date: Jun. 28, 2012

(54) LOCKING DEVICE FOR AN AUTOMOBILE

(75) Inventors: Florian Riedmayr, Ingolstadt (DE); Günther Böhm, Walting (DE)

(73) Assignee: Audi AG, Ingolstadt (DE)

(21) Appl. No.: 13/169,452

(22) Filed: Jun. 27, 2011

(30) Foreign Application Priority Data
Jun. 28, 2010 (DE) 102010025355.3-22

(51) Int. Cl. E05B 65/19

(52) U.S. Cl. 292/226

(57) ABSTRACT

A locking device for an automobile includes a rotary latch supported in the housing for rotation, a locking bracket lockingly engaging with the locking device when the rotary latch is in a locked position, a catch hook having a hook section constructed to securely engage behind the locking bracket when the catch hook is in a catch position, and a locking pawl controlling rotation of the rotary latch. In response to a first unlocking actuation, the locking pawl is unlocked, rotating the rotary latch into the opening direction of rotation up to an unlocking position of the rotary latch which unlocks the locking bracket. In response to a second unlocking actuation, the catch hook rotates into the opening direction of rotation up to a release position of the locking bracket of the locking pawl, thereby releasing the catch hook.

### CROSS-REFERENCES TO RELATED APPLICATIONS

This application claims the priority of German Patent Application, Serial No. 10 2010 025 355.3-22, filed Jun. 28, 2010 pursuant to 35 U.S.C. 119(a)-(d), the content of which is incorporated herein by reference in its entirety as if fully set forth herein.

### BACKGROUND OF THE INVENTION

The present invention relates to a locking device for an automobile, for example, for closing an engine hood.

The following discussion of related art is provided to assist the reader in understanding the advantages of the invention, and is not to be construed as an admission that this related art is prior art to this invention.

For example, FIG. 5 illustrates a locking device for locking a pivotally attached front hood or engine hood of an automobile, wherein the locking device cooperates with a locking bracket arranged on the front hood, and wherein a rotary latch, a catch hook and a locking pawl are arranged for rotation in a housing of the locking device. To open the locking device, separate actuating means, for example in form of two separate Bowden cables, are provided for the catch hook and the rotary latch.

It would therefore be desirable and advantageous to obviate other prior art shortcomings and provide an improved locking device which allows actuation of the rotary latch and catch hook by using only a single actuating means.

### SUMMARY OF THE INVENTION

According to one aspect of the present invention, a locking device for an automobile includes a housing; a rotary latch supported in the housing under spring bias for rotation into an opening direction of rotation and having a recessed latch contour; a locking bracket lockingly received in the latch contour and constructed to be moved into locking engagement with the locking device when the rotary latch is in a locked position; and a catch hook supported in the housing for rotation under spring bias into a closing direction of rotation opposing the opening direction of rotation, wherein the catch hook has a hook section constructed to securely engage behind the locking bracket when the catch hook is in a catch position. The locking device further includes a locking pawl supported in the housing for rotation under spring bias and having a locking section, wherein when the rotary latch is locked, the locking section inhibits rotation of the rotary latch into the opening direction of rotation through engagement with a locking contour of the rotary latch. Conversely, when the locking pawl is first unlocked against the spring bias of the rotary latch in response to a first unlocking actuation, the locking section enables rotation of the rotary latch into the opening direction of rotation up to an unlocking position of the rotary latch which unlocks the locking bracket. The locking device also includes a coupling lever which is pivotally connected to the locking pawl so as to be biased against a cam contour of the rotary latch, the cam contour controlling movement of the coupling lever. The controlling cam contour is formed such that a coupling end of the coupling lever is released in the locked position of the rotary latch and is in coupling engagement with a coupling section of the catch hook in the unlocked position of the rotary latch and in the catch position of the catch hook, allowing the catch hook to rotate into the opening direction of rotation up to a release position of the locking bracket in response to a second unlocking actuation of the locking pawl opposing the spring bias of the rotary latch, thereby releasing the catch hook.

According to an advantageous feature of the invention, the locking device may be configured for transverse and lengthwise installation in the automobile.

With the cooperation according to the invention between locking pawl, coupling lever and cam contour of the rotary latch, the catch hook and the rotary latch can be operated by using only a single actuating means for opening the locking device, namely the locking pawl, or for example a single Bowden cable attached to the locking pawl. According to the invention, it is thereby ensured that the catch hook reaches its release position only by way of the second unlocking actuation of the locking pawl. In other words, a two-stroke-actuation with a single actuating means, for example from an passenger compartment, is provided.

With the control function of the rotary latch of the invention for actuating the catch hook, a primary locking function realized via the cam contour of the rotary latch and a secondary locking function realized via the hook section of the catch hook may be advantageously combined in a single component (the rotary latch).

According to an advantageous feature of the invention, the catch hook and the rotary latch may be arranged on a common rotation axis.

The locking device according to the invention can thus be manufactured cost-effectively, requiring little installation space.

According to an advantageous feature of the invention, the rotary latch may have an engagement contour, wherein the catch hook may have an engagement section which is in coupled engagement with the engagement contour of the rotary latch such that in the unlocked position of the rotary latch, the catch hook is moved against its spring bias from an over-catch position corresponding to the locked position of the rotary latch into its catch position.

The term over-catch position in the context of the present invention refers to a position located after the catch position in the closing direction of rotation, i.e., beyond the catch position, ensuring that the hook section securely engages behind the locking bracket.

With the coupling connection according to the invention between the engagement section and the engagement contour, a rotary drive of the catch hook opposing its spring bias may be realized in a simple and robust manner, wherein the rotary latch assumes control of the catch hook. To this end, the spring bias of the rotary latch preferably provides a higher spring torque than the spring bias of the catch hook.

According to another advantageous feature of the invention, the locking device may further include a catch hook lock supported for rotation in the housing with a spring bias, such that in the catch position, a locking section of the catch hook lock is in engagement with a first locking contour of the catch hook, thereby holding the catch hook in its catch position against the spring bias.

In this way, the catch hook is securely held in its catch position after the rotary latch is rotated into its unlocked position by the first unlocking actuation of the locking pawl. For example, an actuating lever in the passenger compartment connected, for example, via a Bowden cable with the locking pawl, can then be comfortably released or extended after the first unlocking actuation of the actuating lever in order to carry out the second unlocking actuation of the actuating lever at a desired later time.

According to still another advantageous feature of the invention, the catch hook may have a second locking contour, such that the locking section of the catch hook lock is in engagement with the second locking contour of the catch hook in the release position of the catch hook, thereby holding the catch hook in its release position against its spring bias.

In this way, the catch hook is securely held in its release position after the second unlocking actuation of the locking pawl, so that the locking bracket which is preferably attached on a front hood, e.g. the engine hood of the automobile, can be freely and safely lifted out of the locking device.

According to another advantageous feature of the invention, the first locking contour may be arranged before the second locking contour with a predetermined angular distance, when viewed in the opening direction of rotation.

With this embodiment of the invention, the second unlocking actuation of the locking pawl advantageously has a greater stroke than the first unlocking actuation of the locking pawl, thereby providing additional safety by preventing the locking device of the invention from being accidentally completely opened. An operator of the automobile must, in order to secure the catch hook in its release position, intentionally execute a greater stroke during the second unlocking actuation, which almost entirely prevents accidental actuations.

According to yet another advantageous feature of the invention, the rotary latch may have an additional cam contour for controlling movement of the catch hook lock, wherein the additional controlling cam contour may be formed such the locking section of the catch hook lock is disengaged from the first locking contour of the catch hook by rotating the rotary latch in the closing direction against its spring bias, which is produced when the locking bracket is inserted into the locking device in an insertion direction along a penetration path, allowing the catch hook to rotate in the closing direction under its spring bias up to an intermediate catch position located between its catch position and its over-catch position.

This embodiment of the invention ensures in a simple and robust manner that the catch hook can be or is controllably moved by the rotary latch into the closing direction of rotation when the locking device is closed.

The term intermediate catch position refers in the context of the invention to a position which in the closing direction of rotation is located after the catch position, thus ensuring that the hook section securely engages behind the locking bracket.

According to another advantageous feature of the invention, the catch hook may be locked in its intermediate catch position and prevented from rotating farther into the over-catch position through coupling engagement of its engagement section with the engagement contour of the rotary latch.

In this way, the cam contour of the rotary latch can lockingly receive the locking bracket under control of the rotary latch, before the catch hook reaches its over-catch position representing an end position in the closing direction of rotation. This prevents in a simple and robust manner the catch hook from interfering with the rotary latch.

According to yet another advantageous feature of the invention, the locking device may further include an actuating device for the catch hook lock, wherein the actuating device has a catch hook lock pawl which is arranged in the penetration path such that the catch hook lock pawl is displaced from the penetration path upon insertion of the locking bracket and actuates the catch hook lock with a catch hook lock coupling, such that the locking section of the catch hook lock is disengaged from the second locking contour of the catch hook, thereby allowing the catch hook to rotate due to its spring bias in the closing direction up to its catch position.

With the actuating device according to the invention, the locking bracket is reliably secured and/or held by the catch hook in a simple and safe manner even if the locking bracket is only slightly inserted into the locking device, thereby reliably preventing the front hood of the automobile from being lifted up, for example due to the airflow. Preferably, the own weight provided by the front hood and the attached locking bracket is sufficient to release the actuating device, so that the catch hook falls into its catch position.

According to another advantageous feature of the invention, the locking device may further include an ejector supported for rotation in the housing with a spring bias, so that an ejector section of the ejector arranged in the penetration path opposes penetration of the locking bracket into the locking device.

With the advantageous integration of the ejector into the locking device, the locking bracket can be comfortably lifted out of the locking device, for example by manually lifting the front hood, in a cost-effective manner and with minimal installation complexity.

According to another advantageous feature of the invention, the ejector may be spring-biased such that the locking bracket is held at a lift-out height through static contact on the ejector section, with the lift-out height being above the height of the rotary latch when the latch contour of the rotary latch is in its unlocked position, allowing the hook section of the catch hook to engage behind the locking bracket in the catch position.

With the slightly increased lift-out height, a sufficiently wide gap is provided between the front hood and the front grill of the vehicle for insertion of a hand, so that the locking bracket can be lifted out even more comfortably. By enabling the hook section of the catch hook to engage behind the locking bracket at the lift-out height, the ejector does not interfere with the safety function of the catch hook.

According to still another advantageous feature of the invention, the locking device may further include an electric monitoring device which is configured to monitor a locked state of the locking device and to output corresponding locked state signals, and an electromechanical actuator which is configured to perform an actuating movement in response to a signal from the monitoring device corresponding to the release position of the catch hook and in response to a signal from a vehicle control device corresponding to an engine start of the automobile, thereby moving the catch hook from its release position into its catch position.

With the combination of the electric monitoring device and the electromechanical actuator, the catch hook can advantageously be moved with the actuator or actuating element into the catch position (hook section engages on the locking bracket) while the rotary latch is in the open position in the event of an erroneous actuation (for example, an operator of the automobile unlocks the locking device by pulling the actuating lever in the vehicle interior space twice and subsequently resumes travel without completely locking the locking device), thereby ensuring secure latching.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows a perspective exploded view of an embodiment of a locking device according to the invention;

FIG. 2 shows in a schematic view a closed state of the locking device according to the invention, before the locking device is opened;

FIG. 3 shows in a schematic view a catch position state of the locking device according to the invention, which occurs while the locking device is opened;

FIG. 4 shows in a schematic view the locking device according to the invention in an open state;

FIG. 5 shows the locking bracket being lifted out of the locking device according to the invention, when the locking device is in the open state;

FIG. 6 shows in a schematic view the engagement of the locking bracket with the open locking device according to the invention, when the locking device is closing;

FIG. 7 shows in a schematic view the catch position state of the locking device according to the invention which occurs again during closing;

FIG. 8 shows in a schematic view the disengagement of the coupling lever when the locking device is closing, when the locking device according to the invention is in the catch position state;

FIG. 9 shows in a schematic view the release of the catch hook when the locking device is closing, when the locking device according to the invention is in an intermediate catch position state;

FIG. 10 shows in a schematic view the closed state of the locking device according to the invention after the locking device is closed;

FIG. 11 shows only the components of the secondary closing function implemented by of the catch hook 30; and

FIG. 12 shows only the components of the primary closing function implemented with the rotary latch 20 and its kinematics.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

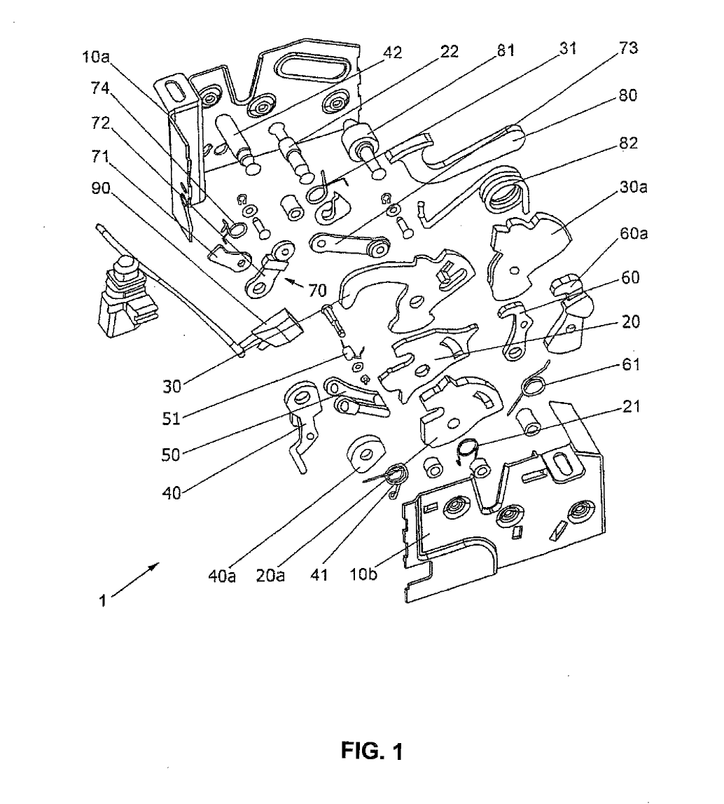

Turning now to the drawing, a locking device 1 according to one embodiment of the invention for an automobile (not shown) is described with reference to FIGS. 1 to 12.

The locking device 1 is preferably used for locking a front hood (such as an engine hood) of the automobile, whereby the locking device 1 is mounted on a front cross beam of the automobile for movement into locking engagement with, for example, a U-shaped locking bracket S mounted on a lower front edge of the front hood.

The locking device 1 has a two-part housing 10 with a rear housing half 10a and a front housing half 10b.

The locking device 1 has in the housing 10 a plate-shaped rotary latch 20, a plate-shaped catch hook 30, a plate-shaped locking pawl 40, a forked-shaped coupling lever 50, a plate-shaped catch hook lock 60, a plate-shaped ejector 80, a monitoring device 90 in form of a microswitch and an electromechanical actuator (not shown).

The rotary latch 20 is compressively spring-biased by a rotary latch spring 21 into an opening direction of rotation (in the figures clockwise) and rotatably supported in the housing 10 by a rotary latch step pin 22.

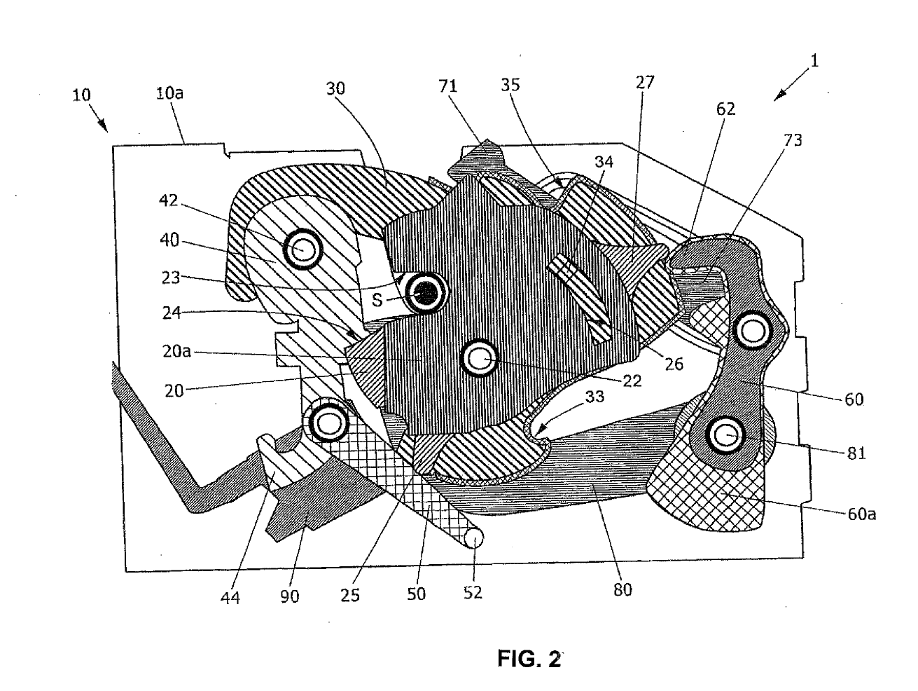

The rotary latch 20 has a latch contour 23 which is recessed in form of a U-shape for lockingly receiving the locking bracket S, which is to be moved into locking engagement with the locking device 1, in a locked position of the rotary latch 20 illustrated in FIG. 2. The rotary latch 20 has additionally a rotary latch casing 20a which is placed laterally on the rotary latch 20.

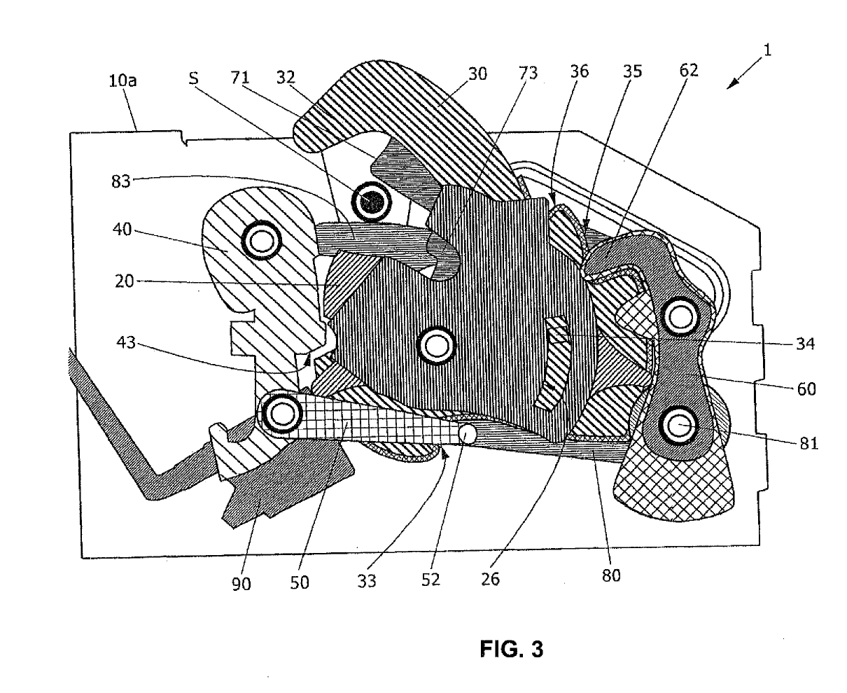

The catch hook 30 is compressively spring-biased in a closing direction of rotation (in the figures counterclockwise) which opposes the opening direction of rotation and is supported for rotation in the housing 10 by of the rotary latch step pin 22. Accordingly, the catch hook 30 and the rotary latch 20 are arranged as separate parts on a common rotation axis (the rotary latch step pin 22). The catch hook 30 further has a catch hook casing 30a which is placed laterally on the catch hook 30. The catch hook 30 further has a hook section 32 for securely engaging behind the locking bracket S in a catch position of the catch hook 30, as illustrated in FIG. 3.

The locking pawl 40 is compressively spring-biased counterclockwise by a locking pawl spring 41 and supported for rotation in the housing by a locking pawl step pin 42, so that in the locked position of the rotary latch 20 illustrated in FIG. 2, a locking section 43 (see FIG. 3) of the locking pawl 40 inhibits rotation of the rotary latch 20 in the opening direction of rotation by way of the engagement with a locking contour 24 (see FIG. 2) of the rotary latch 20.

The locking pawl 40 is furthermore spring-biased and supported such that the locking section 43 of the rotary latch 20 is disengaged from the locking contour 24 of the rotary latch by a first unlocking actuation of an actuating section 44 of the rotary latch 20, thereby enabling rotation of the rotary latch 20 in the opening direction of rotation up to an unlocked position of the rotary latch 20 illustrated in FIG. 3, which unlocks the locking bracket S. The locking pawl 40 additionally includes a locking pawl casing 40a which is placed laterally on the locking pawl 40.

The coupling lever 50 is spring-biased counterclockwise by a coupling lever spring 51 and attached on the locking pawl 40 for rotation by way of a socket pin (not labeled) so as to pretension the coupling lever 50 against a first cam contour 25 of the rotary latch 20 which is provided for controlling movement of the coupling lever 50 and implemented in form of a control cam.

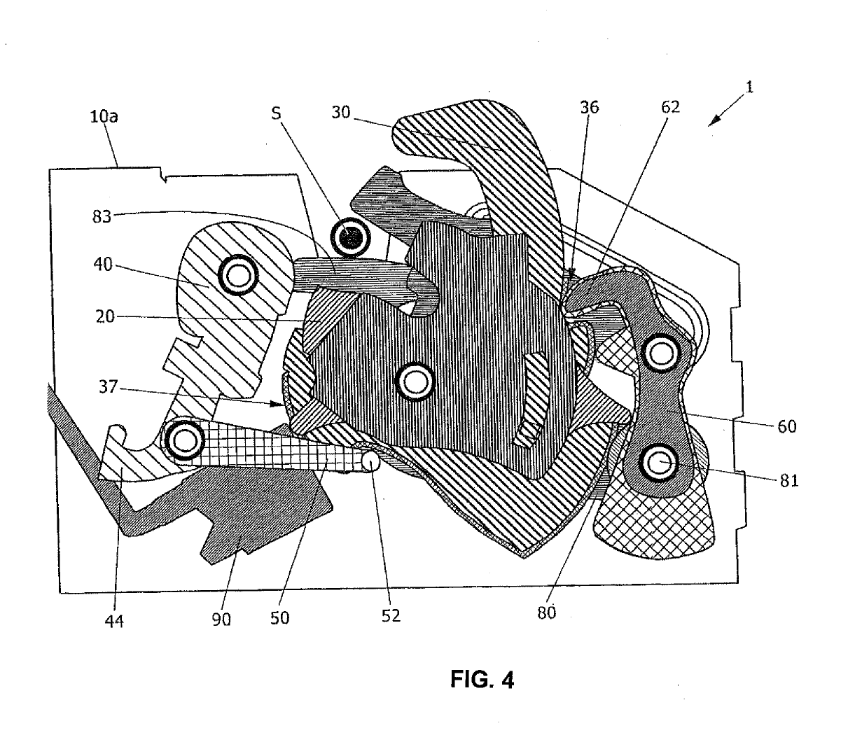

The controlling first cam contour 25 is shaped so that a coupling end 52 of the coupling lever 50 is released when the rotary latch 20 is in the locked position illustrated in FIG. 2, and is in coupling engagement or can assume a form-fitting engagement with a coupling section 33 of the catch hook 30 when the rotary latch 20 is in the unlocked position illustrated in FIG. 3, so that the catch hook 30 can be rotated in the opening direction of rotation to the unlocked position illustrated in FIG. 4 by a second unlocking actuation of the actuating section 44 of the locking pawl 40 directed against the spring bias (meaning clockwise), thereby releasing the locking bracket.

The rotary latch 20 moreover has an engagement contour 26 formed as a rotary latch recess, and the catch hook 30 likewise has an engagement section 34 formed as a projection which is in coupling engagement or in formfitting engagement with the engagement contour 26 of the rotary latch 20, so that the catch hook 30 is moved against its spring bias from an over-catch position illustrated in FIG. 1 into its catch position illustrated in FIG. 3, when the rotary latch 20 is in the unlocked position illustrated in FIG. 3.

The catch hook lock 60 is compressively spring-biased counterclockwise by a catch hook locking spring 61 and rotatably supported in the housing by an ejector step pin 81, so that in the catch position of the catch hook 30 illustrated in FIG. 3, a hook-shaped locking section 62 of the catch hook lock 60 is in engagement with a first locking contour 35 of the catch hook 30 formed as a tooth-shaped or stepped recess, thereby holding the catch hook 30 in its catch position against its spring bias. The catch hook lock 60 also has a catch hook lock casing 60a which is placed laterally on the catch hook lock 60.

The catch hook 30 furthermore has a second locking contour 36 formed as a tooth-shaped or stepped recess, so that the locking section 62 of the catch hook lock 60 is in engagement with the second locking contour 36 of the catch hook in the release position of the catch hook 30 illustrated in FIG. 4, thereby holding the catch hook in its release position against its spring bias.

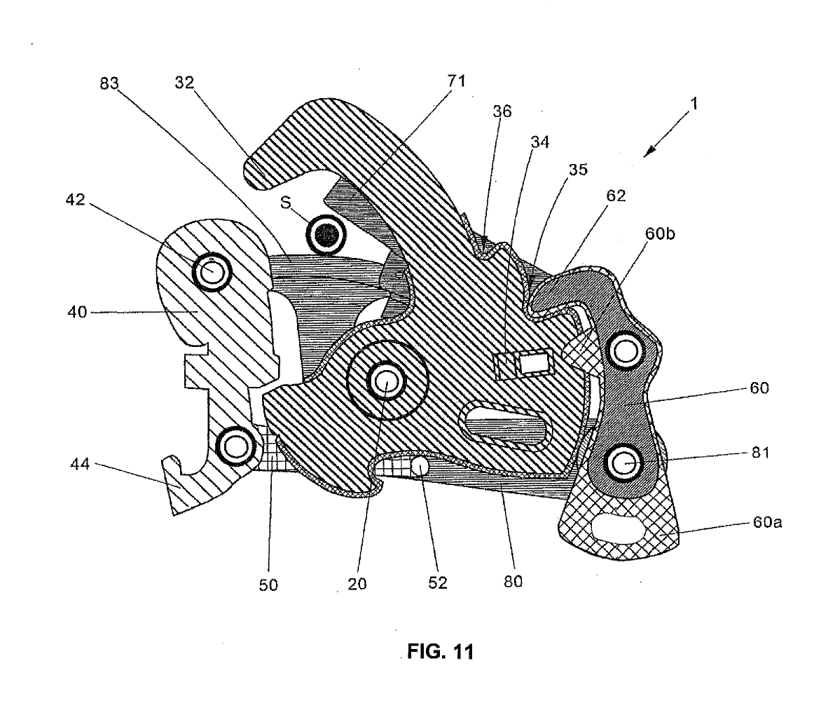

As best seen from FIG. 11, the first locking contour 35 is arranged (as seen in the opening direction of rotation) at a predetermined angular distance from the second locking contour 36.

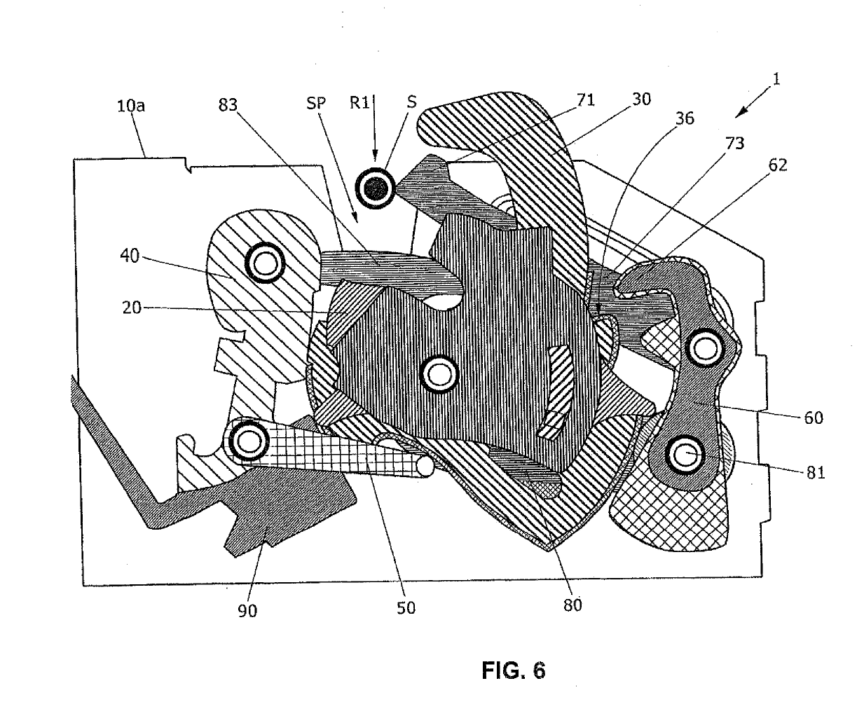

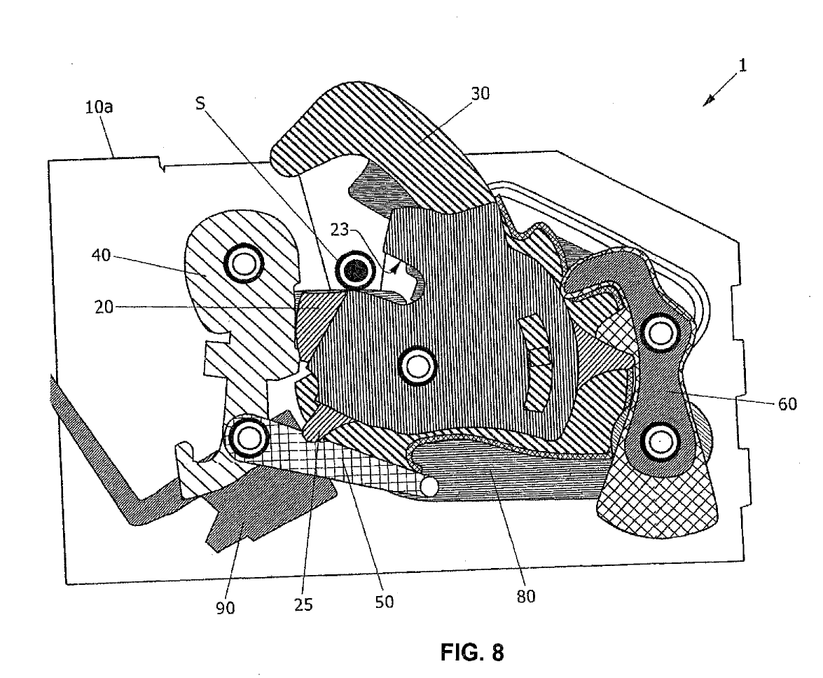

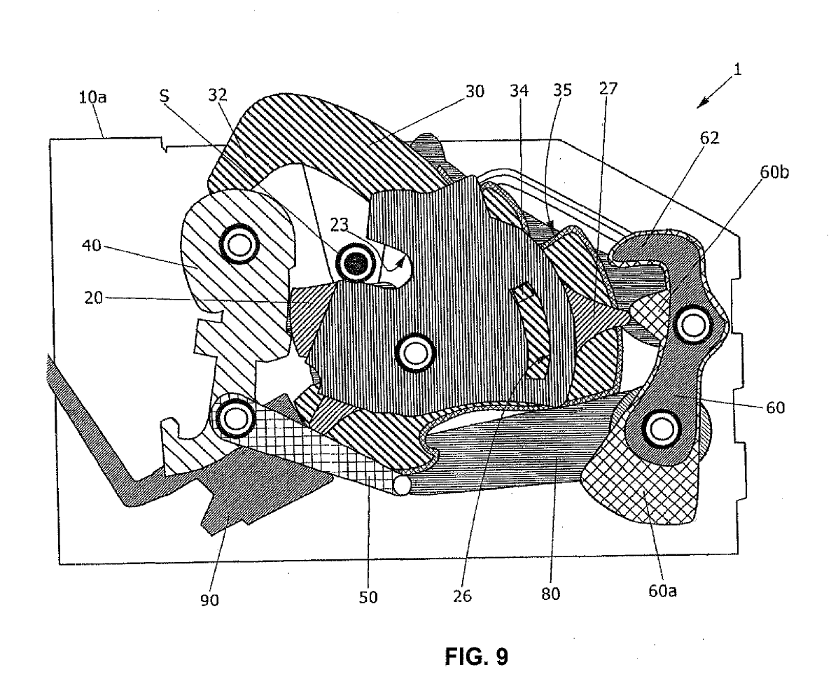

The rotary latch 20 additionally has a second cam contour 27 implemented as a control cam for controlling movement of the catch hook lock 60. The controlling second cam contour 27 is shaped such that the locking section 62 of the catch hook lock 60 is disengaged from the first locking contour 35 of the catch hook 30 if the locking bracket S penetrates into the locking device 1 in a penetration direction R1 (see FIG. 6) along a penetration path SP and the rotary catch 20 is rotated in the closing direction opposing the spring bias (see FIG. 8 to FIG. 9) of the rotary catch 20, allowing the catch hook 30 to rotate—aided by spring bias—in the closing direction up to its intermediate catch position located between its catch position and the over-catch position.

In the intermediate catch position illustrated in FIG. 9, the catch hook 30 is prevented by the coupling engagement of its engagement section 34 with the engagement contour 26 of the rotary latch 20 from rotating farther into the over-catch position.

The actuating device 70 for the catch hook lock 60 has a catch hook lock pawl 71, a catch hook lock lever 72 coupled with the catch hook lock pawl 71, and a catch hook lock coupling 73 coupled with the catch hook lock lever 72. The catch hook lock pawl 71 is spring-biased counterclockwise by a catch hook lock pawl spring 74 and rotatably attached on the catch hook lock lever 72 by a socket pin (not labeled). The catch hook lock lever 72 is rotatably supported in the housing by a rotary latch step pin 22. The catch hook lock coupling 73 is rotatably attached on the catch hook lock 60 by a socket pin (not labeled) located (in the Figures) above the ejector step pin 81.

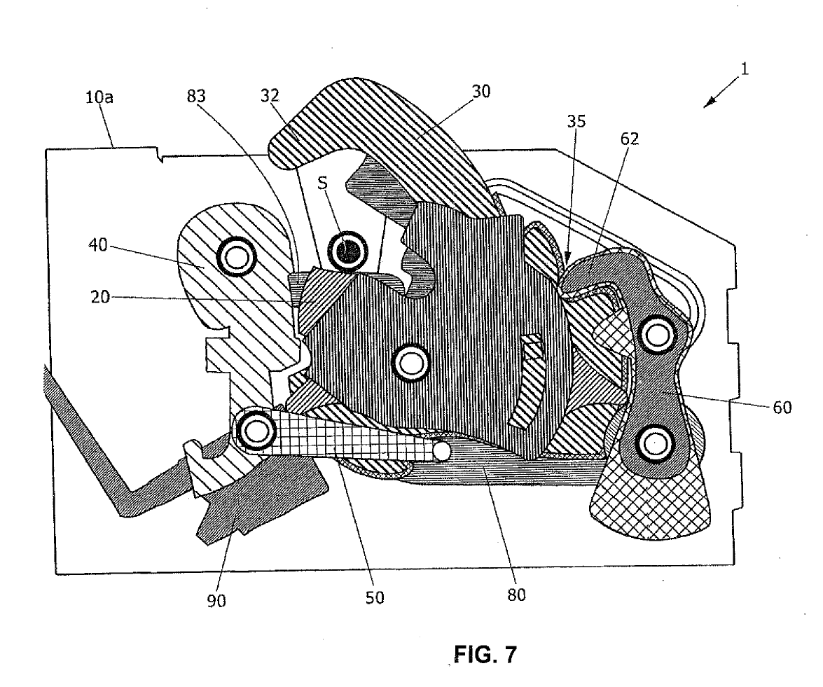

The catch hook lock pawl 71 of the actuating device 70 is arranged in the penetration path SP of the locking bracket S so as to displace the catch hook lock pawl 71 when the locking bracket S is inserted (see FIG. 6), and the catch hook lock 60 is actuated via the catch hook lock coupling 73 so as to disengage the locking section 62 of the catch hook lock 60 from the second locking contour 36 of the catch hook 30, allowing the catch hook 32 to rotate under its spring bias in the closing direction up to its catch position, as illustrated in FIG. 7.

The ejector 80 is spring-biased clockwise by an ejector spring 82 and supported for rotation in the housing 10 by the ejector step pin 81, so that an ejector section 83 of the ejector 80 arranged in the penetration path SP counteracts the penetration of the locking bracket S into the locking device 1 (see FIG. 6 to FIG. 9).

The ejector 80 is hereby spring-biased such that the locking bracket S is held at a lift-out height illustrated in FIG. 3 and FIG. 4, when in static contact (i.e., wherein the locking bracket S is not moving) on the ejector section 83, which lies above a rotary latch height, where the latch contour 23 of the rotary latch 20 is in the unlocked position illustrated in FIG. 3 and FIG. 4. As seen from FIG. 3 and FIG. 4, the lift-out height enables the hook section 32 of the catch hook 30 to engage behind the locking bracket S.

The electric monitoring device 90 is configured to monitor a locked state of the locking device 1 via (unillustrated) touch contacts and to output corresponding locked state signals.

The actuating element which may, for example, operate electromagnetically is configured to perform an actuating movement in response to a signal from the monitoring device corresponding to the release position of the catch hook 30 shown in FIG. 4, which is generated when a touch section 37 of the catch hook 30 strikes a sensing device (not shown) of the monitoring device 90, and a signal from a vehicle control device (not shown) corresponding to an engine start of the automobile, thereby moving the catch hook 30 from its release position shown in FIG. 4 to its catch position shown in FIG. 3 and FIG. 7.

To this end, the actuating element can operate, for example electromagnetically, on the catch hook lock lever 72 so that the catch hook lock 60, as shown in FIG. 6, is disengaged from the second locking contour 36 of the catch hook, allowing the catch hook 30 to rotate under its spring bias in the closing direction up to its catch position, as shown in FIG. 7.

In this way, the catch hook 30 is safely moved by the actuating element or actuator into the catch position (hook segment 32 is engaged on the locking bracket S) when the rotary latch 20 is open, in the event of an accidental actuation (e.g., an operator of an automobile unlocks the locking device 1 by pulling twice on the actuating lever in the vehicle interior compartment and resumes subsequently the travel without completely locking the locking device 1), thereby ensuring secure locking.

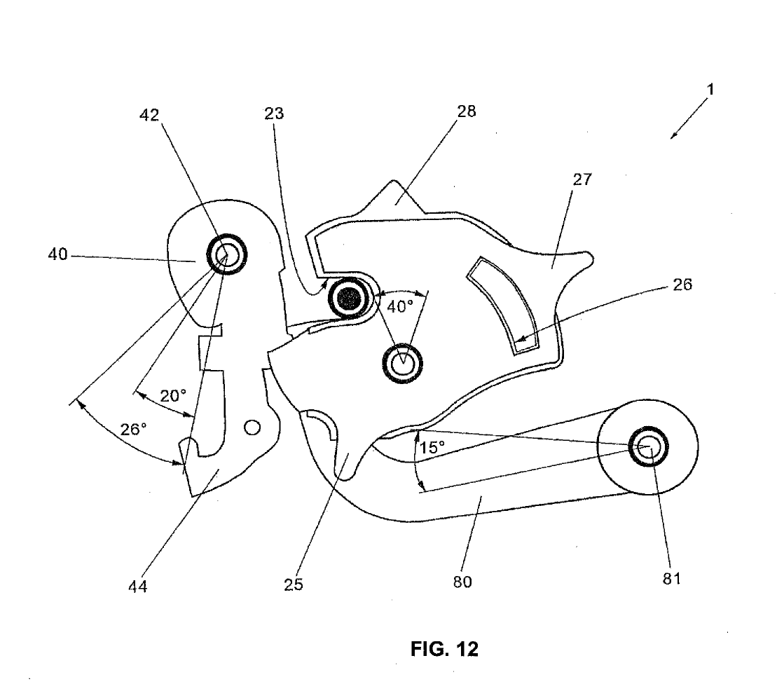

For a better explanation, FIG. 11 shows again only the components of the secondary closing function implemented by of the catch hook 30. Also for a better explanation, FIG. 12 shows once more only the components of the primary closing function implemented with the rotary latch 20 and its kinematics.

The opening process and the closing process of the locking device 1 will be described again below with reference to FIGS. 2 to 10.

FIG. 2 represents the closed state of the locking device 1 according to the invention. The rotary latch 20 which is spring-biased clockwise is held by the locking section 43 (a contact surface) of the locking pawl 40 which is biased counterclockwise in its locked position. The monitoring device 90, which is embodied as a microswitch and cooperates with the ejector 80, shows a closed signal.

If the locking pawl 40 is deflected according to the first unlock actuation by 20° clockwise and again released on the actuating lever in the passenger compartment, then the constellation of the components illustrated in FIG. 3 results. The locking device is in its catch position state following the first unlocking actuation or the first stroke.

As shown in FIG. 3, due to its higher spring torque, the rotary latch 20 has lifted the catch hook 30 up and has rotated by 40° in the opening direction of rotation (clockwise). A stop (not shown) disposed on the front housing half 10b and cooperating with a stop contour 28 (see FIG. 12) limits the stroke of the rotary latch. Only the rear housing half 10a is shown in FIG. 3. The catch hook lock 60 latches with its locking section 62 in the first locking contour 35 of the catch hook 30. The ejector section 83 of the ejector has lifted the locking bracket S by about 14 mm into the catch position. The monitoring device 90 signals open. When the actuating lever in the passenger compartment is released, the coupling end 52 of the coupling lever 50 slides over the recessed coupling section 33 of the catch hook 30.

FIG. 4 shows the second unlocking actuation or the second stroke of the locking pawl 40. When, as shown in FIG. 4, the locking pawl 40 is deflected clockwise a second time by about 26°, the catch hook 30 is rotated by the coupling lever 50 by 28° against its leg spring force into the release position. The relative movement is attained when the coupling end 52 of the coupling lever 50 hooks to the intended coupling section 33 of the catch hook 30. The catch hook lock 60 secures the catch hook 30 in the release position, with the locking section 62 of the catch hook lock 60 interlocking with the second locking contour 36 of the catch hook 30. The locking bracket S and therefore also the front hood are now completely released and can be lifted up.

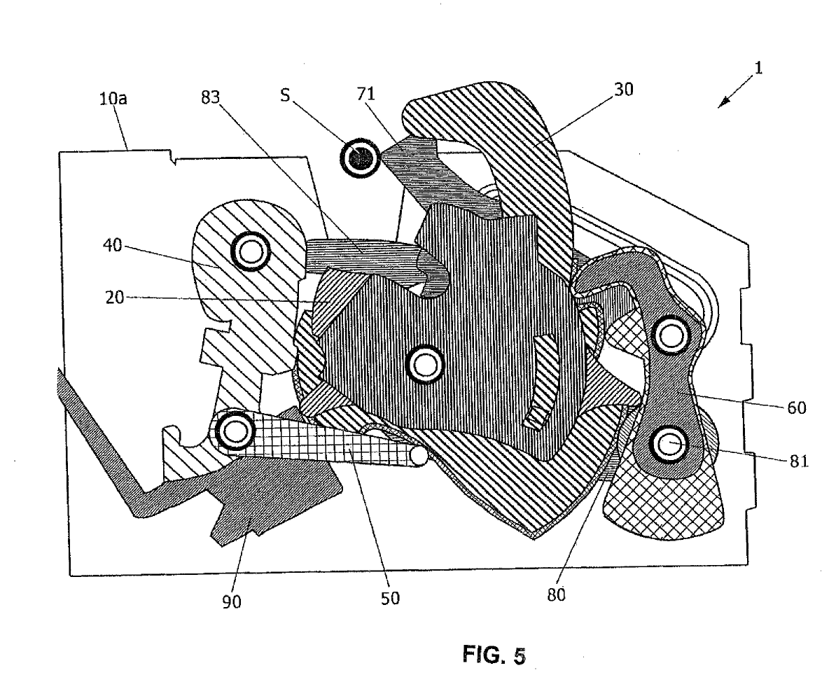

The last step of the opening process illustrated in FIG. 5 describes lifting of the locking bracket S and/or of the front hood. The catch hook lock pawl 71 of the actuating device 70, which is spring-biased counterclockwise, is deflected by about 17.6° before returning to its initial position.

The closing process of the locking device 1 now follows, beginning with FIG. 6. When the front hood (e.g., engine hood) is closed, the locking bracket S slides from the catch hook lock pawl 71 and pushes the catch hook lock 60 to the side with the articulated mechanism of the actuating device 70. The interlock between the locking section 62 of the catch hook lock 60 and the second locking contour 36 of the catch hook 30 is then released. The catch hook can now rotate back to the catch position under its spring bias, as shown in FIG. 7.

In FIG. 7, the catch hook 30 is again in the catch position. The locking section 62 of the catch hook lock 60 is in engagement with the first locking contour 35 of the catch hook 30 and prevents the catch hook 30 for rotating farther in the closing direction of rotation. The ejector section 83 of the ejector is lowered by the locking bracket S to the height of the rotary latch.

Because the catch hook 30 is fixed, the rotary latch 20 can perform a relative movement in the closing direction of rotation, as illustrated in FIG. 8. When the rotary latch 20 has rotated in the closing direction of rotation by 10°, the coupling lever 50 is pushed out by the first cam contour 25 of the rotary latch 20 by 10° clockwise. This is necessary to prevent jamming between the catch hook 30 and the coupling lever 50 when the system closes.

When, as shown in FIG. 9, the coupling and 52 of the coupling lever 50 is located outside the coupling section 33 of the catch hook 30, the catch hook can be released and rotate into the intermediate catch position. To this end, the catch hook lock 60 is swung outwardly clockwise by way of the second cam contour 27 of the rotary latch 20 and a cooperating cam section 60b of the catch hook lock casing 60a, whereby the rotation of the catch hook 30 is limited through contact of the engagement section 34 (projection) of the catch hook 30 in the engagement contour 26 (rotary latch recess), as shown in FIG. 9.

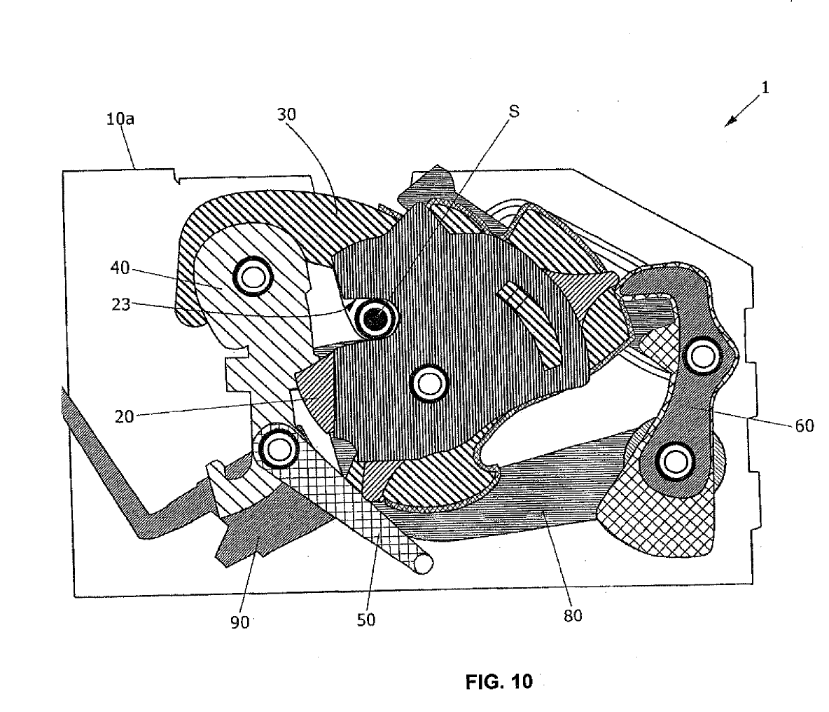

FIG. 10 shows the locking device again is the closed state. The latch contour 23 of the rotary latch 20 which is blocked by the locking pawl 40 then prevents the locking bracket S from being opened and lifting out. The monitoring device 90 signals closed.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A locking device for an automobile, comprising:
a housing;
a rotary latch supported in the housing for rotation under spring bias into an opening direction of rotation and having a recessed latch contour;
a locking bracket lockingly received in the latch contour and constructed to be moved into locking engagement with the locking device when the rotary latch is in a locked position;
a catch hook supported in the housing for rotation under spring bias into a closing direction of rotation opposing the opening direction of rotation, the catch hook having a hook section constructed to securely engage behind the locking bracket when the catch hook is in a catch position;
a locking pawl supported in the housing for rotation under spring bias and having a locking section, wherein when the rotary latch is locked, the locking section inhibits rotation of the rotary latch into the opening direction of rotation through engagement with a locking contour of the rotary latch, and wherein when the locking pawl is first unlocked against the spring bias of the rotary latch in response to a first unlocking actuation, the locking section enables rotation of the rotary latch into the opening direction of rotation up to an unlocking position of the rotary latch which unlocks the locking bracket, and
a coupling lever which is pivotally connected to the locking pawl so as to be biased against a cam contour of the rotary latch, said cam contour controlling movement of the coupling lever,
wherein the controlling cam contour is formed such that a coupling end of the coupling lever is released in the locked position of the rotary latch and is in coupling engagement with a coupling section of the catch hook in the unlocked position of the rotary latch and in the catch position of the catch hook, allowing the catch hook to rotate into the opening direction of rotation up to a release position of the locking bracket in response to a second unlocking actuation of the locking pawl opposing the spring bias of the rotary latch, thereby releasing the catch hook.

2. The locking device of claim 1, wherein the catch hook and the rotary latch are arranged on a common rotation axis.

3. The locking device of claim 1, wherein the rotary latch comprises an engagement contour and the catch hook comprises an engagement section in coupled engagement with the engagement contour, wherein when the rotary latch is in the unlocked position, the catch hook is moved opposite to its spring bias from an over-catch position corresponding to the locked position of the rotary latch into a catch position.

4. The locking device of claim 3, further comprising a catch hook lock supported with a spring bias in the housing for rotation, wherein a locking section of the catch hook lock is in engagement with a first locking contour of the catch hook when catch hook is in the catch position, thereby holding the catch hook in the catch position against the spring bias.

5. The locking device of claim 4, wherein the catch hook comprises a second locking contour, wherein the locking section of the catch hook lock is in engagement with the second locking contour of the catch hook when the catch hook is in the release position, thereby holding the catch hook in the release position against the spring bias.

6. The locking device of claim 5, wherein the first locking contour is arranged at a predetermined angular distance before the second locking contour, when viewed in the opening direction of rotation.

7. The locking device of claim 4, wherein the rotary latch comprises an additional cam contour for controlling movement of the catch hook lock, wherein the additional cam contour is formed so as to disengage the locking section of the catch hook lock from the first locking contour of the catch hook by rotating the rotary latch into the closing direction against its spring bias in response to insertion of the locking bracket into the locking device in an insertion direction along a penetration path, thereby allowing the catch hook to rotate under its spring bias into the closing direction up to an intermediate catch position located between the catch position and the over-catch position of the catch hook.

8. The locking device of claim 7, wherein the catch hook is locked in the intermediate catch position, preventing further rotation into the over-catch position, through coupling engagement of the engagement section with the engagement contour of the rotary latch.

9. The locking device of claim 7, further comprising an actuating device operating on the catch hook lock, wherein the actuating device comprises a catch hook lock pawl arranged in the penetration path, wherein the catch hook lock pawl is displaced from the penetration path upon insertion of the locking bracket and actuates the catch hook lock by way of a catch hook lock coupling, thereby disengaging the locking section of the catch hook lock from the second locking contour of the catch hook and allowing the catch hook to rotate under spring bias into the closing direction up to the catch position.

10. The locking device of claim 7, further comprising an ejector supported for rotation in the housing with a spring bias and having an ejector section arranged in the penetration path and opposing penetration of the locking bracket into the locking device.

11. The locking device of claim 10, wherein the ejector is spring-biased so as to hold the locking bracket at a lift-out height through static contact on the ejector section, with the lift-out height being located above a rotary latch height where the latch contour of the rotary latch is in the unlocked position, allowing the hook section of the catch hook to engage behind the locking bracket in the catch position.

12. The locking device of claim 1, further comprising:
an electric monitoring device configured to monitor a locked state of the locking device and output corresponding locked state signals; and
an electromechanical actuator configured to perform an actuating movement in response to a signal from the monitoring device corresponding to the release position of the catch hook and in response to a signal from a vehicle control device corresponding to an engine start of the automobile,
thereby moving the catch hook from the release position into the catch position.
